(19) United States
(12) Patent Application Publication
(10) Pub. No.: US 2011/0281721 A1
(43) Pub. Date: Nov. 17, 2011

(54) ADSORBENT MEDIA

(75) Inventor: Robert L Bedard, McHenry, IL (US)

(73) Assignee: UOP LLC, Des Plaines, IL (US)

(21) Appl. No.: 13/133,251

(22) PCT Filed: Sep. 29, 2009
(86) PCT No.: PCT/US09/58675

§ 371 Date: Jun. 7, 2011

Related U.S. Application Data
(60) Provisional application No. 61/121,465, filed on Dec. 10, 2008.

(51) Int. Cl. B01J 20/20; B01J 20/26; B01J 20/28; B01J 20/24

(52) U.S. Cl. 502/79; 502/416; 502/404; 502/402; 502/60

(57) ABSTRACT

Disclosed is an adsorbent media for use in adsorption systems and a method of making the same. The media includes a relatively thin support layer such as paper, an adsorbent such as a zeolite and non-activated pitch-based carbon fibers. The relatively thin layer, porous media provides the advantages of faster mass flow. Because the pitch-based carbon fibers are not activated, they retain their high thermal conductivity and, therefore, provide for fast and efficient heat diffusion through the media.

### STATEMENT OF PRIORITY

This national stage application, filed under 35 U.S.C.§371, claims benefit of priority, under 35 U.S.C.§365, of International Application No. PCT/US2009/058675 filed Sep. 29, 2009, which claims benefit of priority of U.S. Provisional Application No. 61/121,465 filed Dec. 10, 2008.

### FIELD OF THE INVENTION

The disclosure relates to adsorption systems. In particular, it is an adsorbent media for use in such systems.

### DESCRIPTION OF RELATED ART

Adsorption systems, such as HVAC systems, liquid and gas purification, solvent and gasoline vapor recovery and deodorization, sorption cooling processes, certain bulk gas separations, etc., sometimes use adsorption media to remove gas phase impurities or more strongly adsorbed major components in a gas mixture. Adsorption processes and sorption cooling processes typically employ some adsorbent media disposed in a metal vessel, which may be self-supporting or contained on a metal screen or surface. The adsorbent is in contact with a fluid or gas stream containing an adsorbable component over the range of conditions necessary for adsorption.

Some conventional adsorption media are comprised of a thin sheet or layer such as paper, metal foils, polymer films, etc., and an adsorbent material such as silica gel, activated aluminas, activated carbon and molecular sieves such as zeolites. These adsorbent sheets or layers are relatively thin compared to conventional beads, extrudates, or granules. Because thinner media provides a shorter path length from the gas or liquid phase feed to the adsorption site, the mass transfer through these adsorbents is faster than in beads or granules. In addition, the macropore size distribution, particularly in wet laid adsorbent-containing paper, can be roughly an order of magnitude larger than in a typical adsorbent bead. This larger macropore size also increases the mass transfer of the media relative to beads or granules.

With fast mass transfer, it could become difficult to dissipate the heat of adsorption in certain applications. This is especially true with adsorbents comprised of thin film or layer media, which generally have a low thermal conductivity. For example, the thermal conductivity of paper is only 0.05 W/mK. To put this value in context, the thermal conductivity of Styrofoam, a known insulator, is 0.033 W/mK. These relatively low thermal conductivities cause slower heat dissipation throughout the substance. As such, heating of adsorbent paper or certain other thin layer adsorbents during the adsorption cycle may actually slow the approach to equilibrium, thereby reducing the adsorption rate or mass transfer benefits of the thinner adsorbent media. Similarly, with desorption, the temperature of the adsorbing agent can drop substantially due to heat removal by desorption, which could slow the desorption rate of the media.

There is a need for an adsorbent media that provides the mass transfer advantages of thin layer (e.g., sheet, film, foil, plate, paper, etc.) media while avoiding problems associated with dissipation of the heat of adsorption in the thin layer media.

### SUMMARY OF THE INVENTION

The disclosure provides an adsorbent media comprising at least one support material, an adsorbent, and 5 to 30 weight-percent of non-activated pitch-based carbon fibers.

The disclosure also provides an adsorbent media comprising at least one support material selected from the group consisting of paper, metal foils and polymer films, an adsorbent and 5 to 30 weight-percent of non-activated pitch-based carbon fibers, wherein the media comprises a thin porous layer.

The disclosure also provides a method of making an adsorbent media, the method comprising providing a paper slurry comprising water, fibrillated polymer fibers and zeolite powder and formulating pitch-based carbon fibers into the paper slurry.

### BRIEF DESCRIPTION OF THE DRAWINGS

FIG. 1 shows a graph of the heat flux and surface temperature versus time of an adsorbent media without pitch-based carbon fiber, after a first loading cycle.

FIG. 2A shows a graph of the heat flux and surface temperature versus time of the media shown in FIG. 1 with pitch-based carbon fiber, after a first loading cycle.

FIG. 2B shows a graph of the heat flux and surface temperature versus time of the media shown in FIG. 1 with pitch-based carbon fiber, after a second loading cycle.

FIG. 2C shows a graph of the heat flux and surface temperature versus time of the media shown in FIG. 1 with pitch-based carbon fiber, after a third loading cycle.

FIG. 2D shows a graph of the heat flux and surface temperature versus time of the media shown in FIG. 1 with pitch-based carbon fiber, after a fourth loading cycle.

### DETAILED DESCRIPTION

This disclosure relates to adsorbent media. The media may be used in non-industrial processes and industrial processes such as HVAC systems, liquid and gas purification, solvent and gasoline vapor recovery, bulk separation, and deodorization. In particular, the media may be used in rotary adsorbent wheels such as those described in U.S. Pat. No. 7,166,149 to UOP, LLC, Pressure and Temperature Swing Adsorption processes such as those described in U.S. Pat. No. 6,293,998 to UOP, LLC or sorption chillers such as those described in U.S. Pat. No. 6,102,107 to UOP LLC, for example. U.S. Pat. No. 6,102,107 discloses an adsorbent media, such as a paper layer, laminated to first and second sides of fin plates or tubes of a heat exchanger. The adsorbent is in contact with a fluid or gas stream containing an adsorbable component over the range of conditions necessary for adsorption and desorption. In particular, one form of the media may be applied as a coating on a surface of a heat exchanger.

The media of this disclosure is preferably a thin layer of media comprised of a support material, which may be paper, comprised of a fibrous material, for example. The media also comprises binders, a desiccant or adsorbent material and pitch-based carbon fibers. In some cases, the media may be self-supporting. The media may be paper, metal foils, polymer films and the like. An example of a type of paper adsorbent is disclosed in U.S. Pat. No. 5,650,221 to UOP, LLC and is hereby incorporated by reference. The adsorbent paper layer is comprised of a support material, which may be a fibrous material. It also comprises an adsorbent and a binder. The fibrous materials include cellulosic fibers, synthetic fibers and mixtures thereof. Fibrillated fibers, that is, fiber shafts which are split at their ends to form fibrils, i.e., fine fibers or filaments much finer than the fiber shafts, are preferred. Examples of fibrillated, synthetic organic fibers useful in the adsorbent paper of the media are fibrillated aramid and acrylic fibers.

The aramids may be manufactured fibers in which the fiber-forming substance is a long-chain synthetic polyamide in which at least eighty-five percent (85%) of the amide (—CO—NH—) linkages are directly attached to two aromatic rings. Preferred examples of aramids are Twaron or KEVLAR. Twaron, available from Teijin Aramid, is a heat-resistant and strong para-aramid fiber and is available in various lengths and degrees of fibrillation. Examples of Twaron that may be used in the media are Twaron 1094 and 1099. KEVLAR is also a para-aramid. It is available from E.I. du Pont de Nemours & Company and is commercially available as a refined pulp designed for paper forming, such as KEVLAR 303pulp. During refining, the aramid fiber shafts are split at the ends into fibrils by application of high shear, thereby creating a tree-like structure. In the manufacture of paperboard, it has been discovered that the fibrils interlock to enhance the paperboard strength. Aramids are stable in oxidizing atmospheres up to 450° C. Other high-temperature resistant aramids such as NOMEX, available from DuPont, are also suitable for formation of paper in the media.

The adsorbent material can be any material capable of adsorbing an adsorbable component such as water, carbon dioxide, hydrocarbons, nitrogen, or the like. Such materials may be amorphous solids or crystalline compounds. Examples include silica gels, activated aluminas, activated carbon, molecular sieves and mixtures thereof. Other materials which can be used as adsorbents include, for example, halogenated compounds such as halogen salts including chloride, bromide, and fluoride.

Molecular sieves include zeolite molecular sieves. Zeolites are crystalline aluminosilicate compositions which are microporous and which have a three-dimensional oxide framework formed from corner-sharing AlO₂ and SiO₂ tetrahedra. Both naturally occurring and synthetic zeolites can be used in the media. Non limiting examples of zeolites are the family of zeolites of structure types faujasite, A, beta, etc. Faujasite-type zeolites include DDZ-70, Y-54, Y-74, Y-84, Y-85, steam calcined rare earth exchanged Y-54, low cerium rare earth exchanged Y-84, low cerium rare earth exchanged zeolite LZ-210, and other faujasite-type zeolites such as zeolite X and mixtures thereof. DDZ-70 is a rare earth exchanged sodium Y zeolite, such as Y-54, that has been steam calcined, as described in processes in U.S. Pat. No. 5,512,083 and U.S. Pat. No. 5,667,560, both to UOP, LLC, which are incorporated by reference in their entireties. Faujasite-type zeolites are zeolites having a 3-dimensional large pore structure made of secondary building units 4-rings, 6-rings, and double 6-rings. Faujasite-type zeolite pores may have a diameter of 7 Å.

Included in these zeolites are the as-synthesized zeolites and those that have been exchanged with other cations, e.g. Ca+. Non-zeolite molecular sieves are those which do not contain both AlO₂ and SiO₂ tetrahedra as essential framework constituents, but which exhibit the ion-exchange and/or adsorption characteristics of the zeolites. Non limiting examples of non-zeolite molecular sieve adsorbents that may also be used in the media include aluminophosphate, or AlPO molecular sieves, silicoaluminophosphate, or SAPO molecular sieves, silicalite I and silicalite II or other pure silica molecular sieves, and titanosilicate molecular sieves.

The pore size of the zeolitic molecular sieves may be varied by employing different metal cations. For example, sodium zeolite A has an apparent pore size of 4 Å, whereas calcium zeolite A has an apparent pore size of 5 Å. The phrase “apparent pore size” as used herein may be defined as the maximum critical dimension of the molecular sieve in question under normal conditions. The apparent pore size is larger than the effective pore diameter, which may be defined as the free diameter of the appropriate silicate ring in the zeolite structure. Zeolitic molecular sieves in the calcined form may be represented by the general formula:

Me_{2/n}O:Al₂O₃:xSiO₂:yH₂O

where Me is a cation, x has a value from 2 to infinity, n is the cation valence and y has a value of from 2 to 10. The general formula for a molecular sieve composition known commercially as type 13× is:

1.0±0.2Na₂O:1.00Al₂O₃:2.5±0.5SiO₂

plus water of hydration. Type 13× has a cubic crystal structure which is characterized by a three-dimensional network with mutually connected intra-crystalline voids accessible through pore openings which will admit molecules with critical dimensions up to 10 Å. The void volume is 51 volume-percent of the zeolite and most adsorption takes place in the crystalline voids.

The adsorbent may be coated on the paper, foil, film, plate or screen by conventional coating methods such as slip coatings, dipping, spray coating, curtain coating, electrophoretic coating and combinations thereof. Or, the adsorbent may be incorporated into paper sheets during the fabrication of the paper or a combination of adsorbent incorporation during paper making and coating with adsorbent thereafter may be used.

As provided above, preferably, the media is comprised of a thin, porous layer. In particular, it is preferred that the layer is a thin macroporous layer. Preferably, the media has a substantially uniform thickness and is 0.10 mm to 1.00 mm (0.004 to 0.04 inches) thick. Thus, the media is anywhere from one-half (½) to one-twentieth ( 1/20) the thickness of adsorbent beads or granules. As such, the media provides a shorter diffusion path, which allows for a relatively faster rate of mass transfer into and out of the media.

The media comprises at least 30 weight-percent (30%) adsorbent. However, the weight-percent of adsorbent may have some dependence upon the thickness of the media. For instance, it may be easier to prepare 75-80 weight-percent zeolite paper if the final thickness, or caliper, is at least 0.375 mm (0.015 in.) thick. Preferably, the media is no more than 1.00 mm (0.040 in) thick and contains more than 60 weight-percent adsorbent. Preferred ranges of adsorbent content in the media are 60 to 85 weight-percent. In addition, the adsorbent may comprise a uniform density, being adjustable between 0.5 and 1.1 g/cm³ by adjustment of furnish (paper slurry) composition, wet laying conditions, and calendaring treatment.

The media also comprises pitch-based carbon fibers. Preferably, the pitch-based carbon fibers are non-activated, however, a blend of non-activated and activated pitch-based carbon may be used provided that the media comprises 5 to 30 weight-percent of non-activated pitch-based carbon, as explained below. In activated carbon, the carbon is heated, steamed or oxidized after or during carbonization in order to create microporosity, which provides adsorption capacity. Thus, activated carbon fiber is sometimes used as a supplement to or in place of adsorbents such as zeolite.

Often times, the carbon is heated to temperatures of at least 800° C. for activation in the presence of reactive gas such as carbon dioxide. These oxidation conditions degrade the thermal conductivity of the pitch-based carbon fibers. The thermal conductivity of isotropic pitch-based fiber is 10 Watt/m-K in air at 25° C., according to U.S. Pat. No. 6,800,364. The thermal conductivity of isotropic pitch-based fiber after activation is 0.25 Watt/m-K (Vittorio et al., The Transport Properties of Activated Carbon Fibers, J. Mater. Res., Vol. 6, No. 4, April 1991, page 782). Thus, non-activated isotropic pitch-based carbon fiber has a thermal conductivity forty (40) times greater than activated isotropic pitch-based carbon fiber. Mesophase pitch-based carbon fibers will show the same or greater difference in thermal conductivity between activated and non-activated pitch-based carbon fibers. It is likely that activated mesophase pitch-based carbon fibers will experience an even greater reduction in thermal conductivity because mesophase pitch-based carbon fibers generally have a higher thermal conductivity than isotropic pitch-based carbon fibers. Therefore, there is a greater potential for a significant decrease upon activation.

Preferably, the media comprises 5 weight-percent to 30 weight-percent of the non-activated pitch-based carbon fibers. More preferably, the media comprises 10 to 20 weight-percent of non-activated pitch-based carbon fiber. These amounts of pitch-based carbon fibers are used to provide the desired thermal conductivity. The thermal conductivity of the media, such as aramid-zeolite-carbon fiber composites are expected to scale, not necessarily linearly, with the volume fraction of the carbon fibers and also are related to the carbon fiber aspect ratio, which preferably is 5:1 to 20:1 in the media. Therefore, just 1-2 weight-percent of carbon fibers, for example, (which would be 0.5 to 1 in terms of volume percent given the component densities) would be an insufficiently small amount of material to cause an effective increase in the heat transfer ability of the media. Further, if pitch-based carbon fiber is utilized at levels above 30 weight-percent, the level of adsorbent powder must be lowered too much to additionally incorporate enough aramid fiber into the sheet for adequate strength and the resulting capacity of the adsorbent paper would be too low for use in adsorbent process applications.

The pitch-based carbon fibers used are a carbonaceous material derived from mesophase pitch formed from petroleum or coal. The pitch-based carbon fibers can be virtually any commercially-available pitch-based carbon fiber. Preferably, the pitch-based carbon fiber has a relatively high thermal conductivity as compared to that of paper. Such a relatively high thermal conductivity is 20 W/mK to 1000 W/mK. The pitch-based carbon fiber may also have a density of 1.00 g/cc to 3.00 g/cc and a diameter of 5.00 microns (0.0002 in) to 15 microns (0.0006 in). Such pitch-based carbon fibers include those available from Cytec Industries of New Jersey and Toray Carbon Fibers America, Inc. of Alabama.

To prepare a media layer comprising a paper layer, for example, pitch-based carbon fibers are formulated into the paper furnish (slurry), which also contains water, fibrillated polymer fibers such as TWARON or KEVLAR pulps, zeolite powder, and flocculation additives, as described above. The paper furnish may also comprise organic latex and/or inorganic oxide binders. The sheets are prepared by wet-laying the furnish in a paper machine. The resulting paper can be formulated with up to 85 weight-percent zeolite powder and can be used in rapid cycle adsorption processes such as Pressure Swing Adsorption, temperature swing adsorption, vacuum swing adsorption, and combinations thereof, and adsorption heating and cooling processes. As provided above, preferably, the carbon fibers are not activated or, if activated, 5 weight-percent to 30 weight-percent of non-activated pitch-based carbon fibers remain. Providing at least 5 weight-percent to 30 weight-percent of non-activated pitch-based carbon fibers allows the media to retain its thermal conductivity.

In relatively thin layer media, the mass transfer is significantly higher and faster than for adsorbents that may use beads or granules. This is because thinner media provides a substantially shorter path length from the gas or liquid phase feed to the average adsorption site. In addition, the macropore size distribution of adsorbent media is roughly an order of magnitude larger than in typical adsorbent beads. This larger macropore size also increases the mass transfer of the media relative to beads of granules.

However, in conventional media, with faster mass transfer it may become difficult to dissipate the heat of adsorption. In fact, heating the adsorbent due to the adsorption of molecules with high adsorption heats may actually slow the approach to equilibrium, thereby reducing the adsorption rate and mass transfer benefits of the thinner adsorbent media. Similarly, with desorption, the temperature of the adsorbing agent drops due to heat removal by desorption, which lowers the desorption performance of the media.

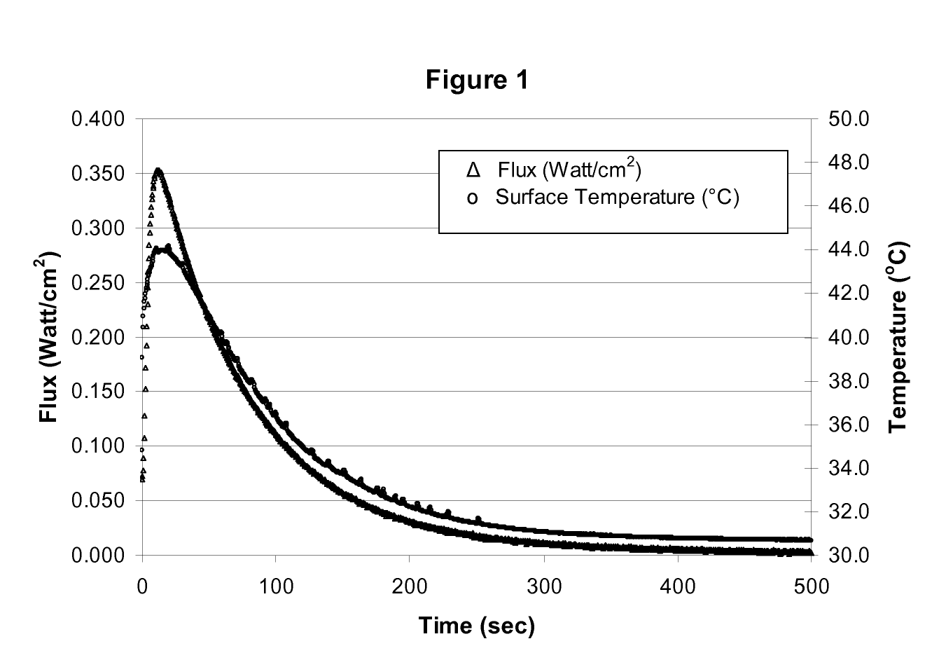

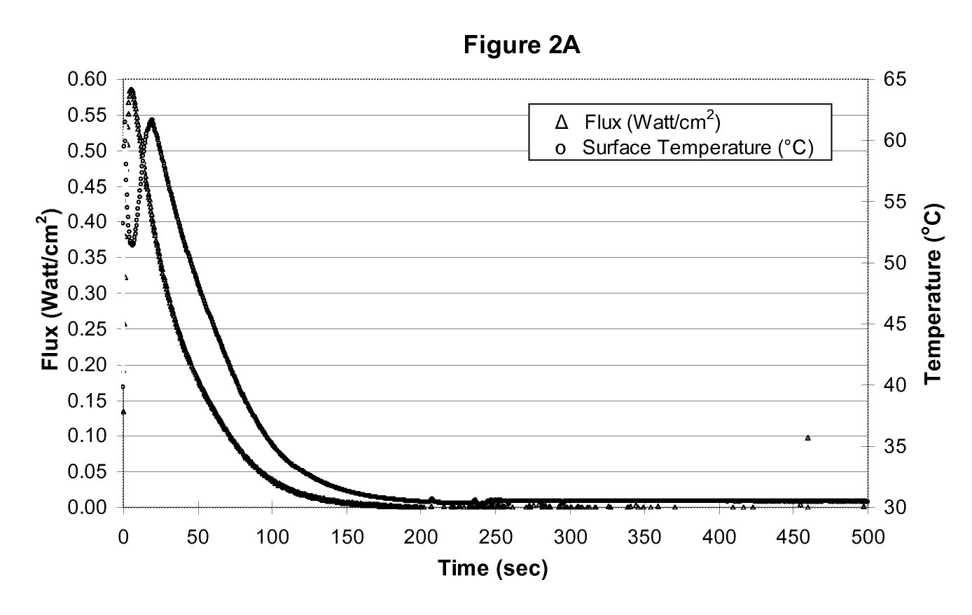

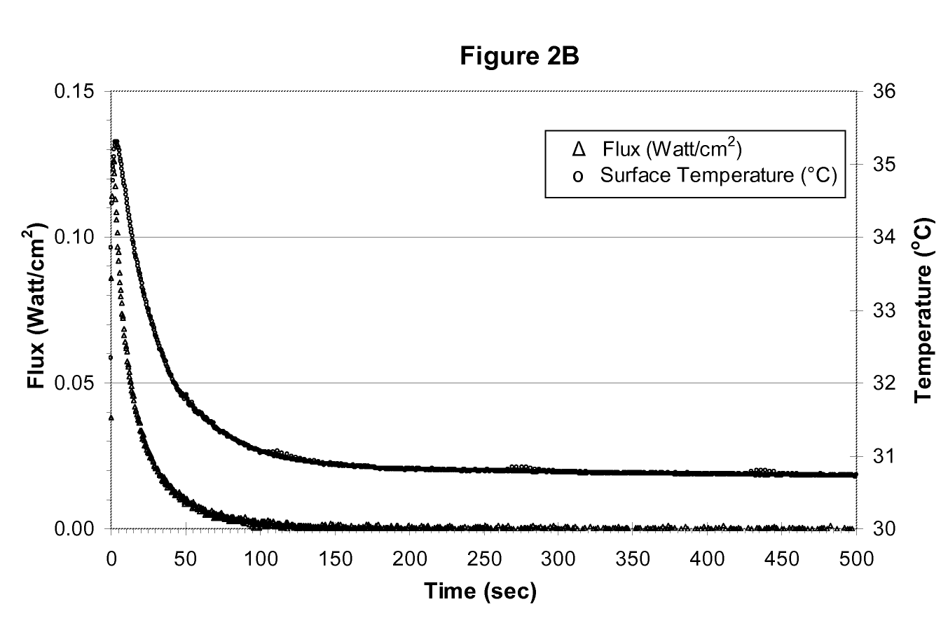

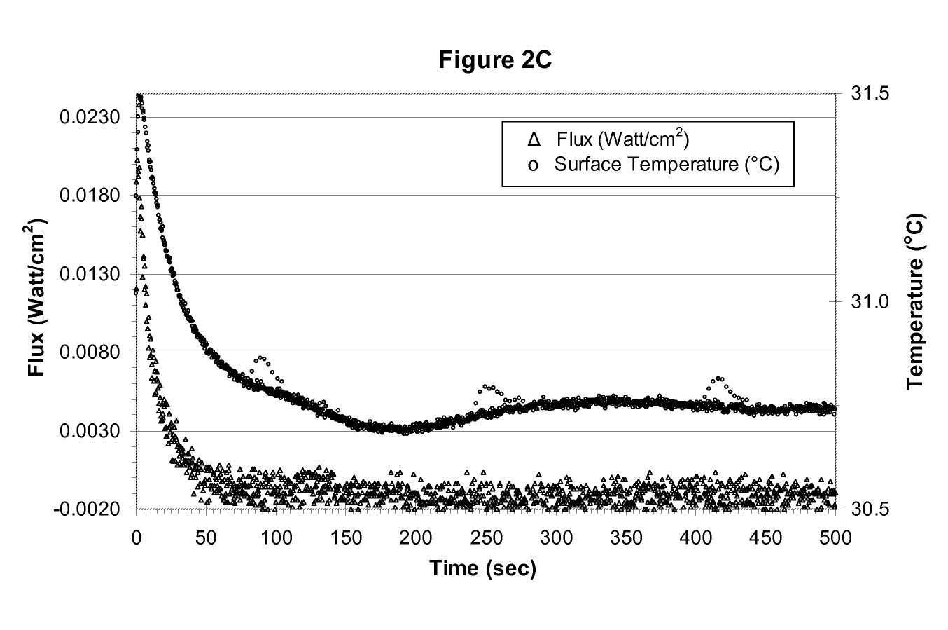

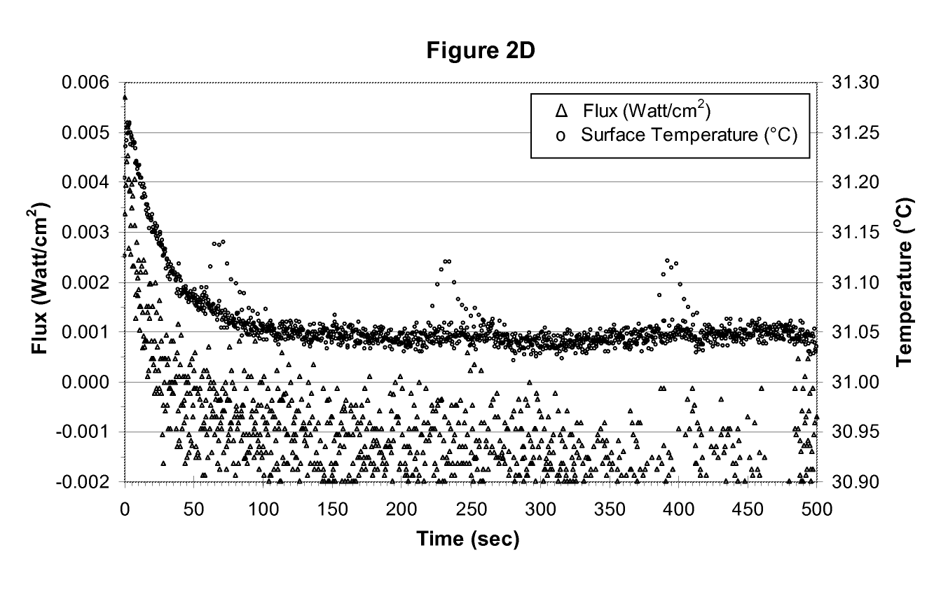

As shown in FIGS. 1 and 2A-2B, and described below, the pitch-based carbon fibers in the media greatly improve the thermal conductivity of the media and, therefore, facilitate diffusion of the heat of adsorption. Thus, the media provides for the increased mass flow resulting from the thinness of the media and the necessary heat dissipation from the pitch-based carbon fibers.

FIG. 1 shows the heat flux and surface temperature of the adsorbent media, which is an aramid/zeolite paper, without pitch-based carbon fiber, after a first loading cycle, which is explained below. FIGS. 2A-2D show the heat flux and surface temperature of the adsorbent media with 20 weight-percent THORNEL brand pitch-based carbon fiber, after four loading cycles. In the Examples shown in FIGS. 1 and 2A-2D, the zeolite used is Y-54 zeolite.

To measure the heat flux and surface temperatures shown in FIGS. 1 and 2A-2D, a heat flux transducer and thermocouple were coupled to the media. The media was positioned in contact with the flux transducer (BF-02 from Vatell Electronics), which was sandwiched between the media sample and a high thermal conductivity heat sink thermostatted to 30.0° C. The heat sink used is a thin stainless steel stage with rapid circulation of fluid on the opposite side from a thermostatted bath. Heat generated or removed in the sample related to adsorption therefore passes into and out of the heat sink through the heat flux transducer as long as the sample temperature is different than that of the heat sink, thereby generating a voltage signal in the flux transducer that is proportional to the magnitude of the heat flow. A fine gauge thermocouple with a response time of a few milliseconds was placed in contact with the other side of the media sample.

This sample cell and attached vacuum system were evacuated. Then, a first loading or dosing cycle was performed. In particular, 10 ton of water vapor at a temperature of 30.0° C. was dosed into a dosing volume, which was then opened to the sample cell, starting the adsorption of the water vapor into the sheet sample. The surface temperature and heat flux were measured as water adsorption ensued and the heat of adsorption caused a change in temperature of the sheet sample. The media was allowed to cool to the ambient temperature of 30.0° C. Then, a second loading cycle was performed. Another 10 torr of water vapor dose was similarly admitted into the system, as described above. The surface temperature and heat flux were measured. This water vapor loading or dosing procedure was performed a total of four (4) times for the media without pitch-based carbon fiber and four (4) times for the media with pitch-based carbon fiber. The available water adsorption capacity was substantially saturated in the process.

As the media becomes increasingly saturated with water, smaller surface temperature increases and lower heat flux voltages are measured after each water vapor dose. This is consistent with what is known in the art; that the heat of adsorption is dependent on the percent loading for a zeolite. For example, in the first loading cycle of the pitch-based carbon fiber media, shown in FIG. 2A, the surface temperature reaches 62° C. In the second loading, however, which is shown in FIG. 2B, the surface temperature reaches only 35° C. In addition, as shown in FIGS. 2A-2D and described below, the time for the media to reach ambient temperature, as measured by heat flux, is reduced with each cycle.

In the first loading cycle of the media without pitch-based carbon fiber, the surface temperature reaches 43° C. The heat flux reaches 0.34 Watt/cm². The heat flux returns to 0 Watt/cm² after 450 seconds, and the surface temperature cools to ambient (30° C.) after 450 seconds. These results are shown in FIG. 1. In the second loading cycle (not shown), the surface temperature reached 37° C. The heat flux reached 0.23 Watt/cm². The heat flux returned to 0 Watt/cm² after 250 seconds and the surface temperature cools to ambient after 250 seconds. In the third loading cycle (not shown), the surface temperature started at 31° C. The heat flux reached 0.5 Watt/cm². The heat flux returned to 0 Watt/cm² and the surface temperature cools to the ambient after 150 seconds. In the fourth loading (not shown), the surface temperature was 31° C. The heat flux reached 0.1 Watt/cm². The heat flux returned to 0 Watt/cm² and the surface temperature cools to the ambient after 120 seconds.

As shown in FIG. 2A, in the first loading cycle of the media with pitch-based carbon fiber, the surface temperature reaches 62° C. The heat flux reaches 0.59 Watt/cm². The heat flux returns to 0 Watt/cm² after 200 seconds and the surface temperature cools to the ambient (30.0° C.) after 200 seconds. In the second loading shown in FIG. 2B, the surface temperature reaches 35° C. The heat flux reaches 0.13 Watt/cm². The heat flux returns to 0 Watt/cm² after 130 seconds and the surface temperature cools to ambient after 180 seconds. In the third loading shown in FIG. 2C, the surface temperature starts at 30.5° C. The heat flux reaches 0.09 Watt/cm². The heat flux returns to 0 Watt/cm² after 90 seconds and the surface temperature appears to cool to the ambient after 160 seconds (there is some noise in this data and uncertainty in the cooling time). In the fourth loading shown in FIG. 2D, the surface temperature is 30° C. The heat flux reaches 0.3 Watt/cm². The heat flux returns to 0 Watt/cm² and the surface temperature cools to ambient after 50 seconds.

FIGS. 1 and 2A-2D in essence show how much heat is dissipated over time. As described above, the heat generated during adsorption in the media with pitch-based carbon fiber dissipates much more quickly than the heat generated during adsorption in the media without pitch-based carbon fiber. For example, it took only 200 seconds for the heat flux to return to 0 Watt/cm² in the first run with the pitch-based carbon fiber media whereas it took 450 seconds for the heat flux to return to 0 Watt/cm² in the first run using the carbon fiber media without pitch-based carbon fiber. Likewise the increase in surface temperature generated by the heat of adsorption of the media with pitch-based carbon fibers cools to the ambient temperature more quickly than the increase in surface temperature of the media without pitch-based carbon fibers. These measurements of heat flux and surface temperature over time are a true measure of the improvement in heat dissipation that the pitch-based carbon fiber media provides.

In another form, the media is adapted to be coated on the surface of, for example, a heat exchanger. In this form, the media may be comprised of organosiloxane resins in organic slurry together with zeolite adsorbents or alternatively may be comprised of inorganic binders in an aqueous slurry together with zeolite adsorbents. The media may also be comprised of pitch-based carbon fibers. These pitch-based carbon fibers are preferably non-activated, however, they may comprise a mixture of activated and non-activated pitch-based carbon fibers. The media and the method of coating provided allows the media to be coated on a relatively larger and more complex or convoluted surface area (for example, an undulating surface) than conventional media. The process of heat-treating to set the binders into a hard, adsorbent coating is designed to avoid compromising the thermal conductivity properties of the pitch-based carbon fibers. For example, the volatile components of the coating slurry are removed by heating to temperatures between 450° C. and 600° C. in an inert or reducing atmosphere or under vacuum.

Although the media has been described in terms of exemplary embodiments, it is not limited thereto. Rather, the appended claims should be construed broadly to include other variants and embodiments which may be made by those skilled in the art without departing from the scope and range of equivalents. This disclosure is intended to cover any adaptations or variations discussed herein. An apparatus as described above with reference to the foregoing description and appended drawings is hereby claimed.

1. An adsorbent media comprising:
at least one support material;
an adsorbent; and
5 to 30 weight-percent of non-activated pitch-based carbon fibers.

2. The media of claim 1, wherein the support material is selected from the group consisting of paper, metal foils and polymer films.

3. The media of claim 1, wherein the adsorbent is comprised of zeolite.

4. The media of claim 1, comprising at least 60 weight-percent of adsorbent.

5. The media of claim 1, having a substantially uniform thickness of 0.10 mm to 1.00 mm.

6. The media of claim 1, comprising 20 weight-percent of the pitch-based carbon fibers.

7. The media of claim 1, wherein an increase in surface temperature of the media generated by the heat of adsorption returns to an ambient temperature faster than an increase in surface temperature of a like media without the pitch-based carbon fibers.

8. The media of claim 1, wherein the media comprises a thin, porous layer.

9. The media of claim 2, wherein the support material is a para-aramid.

10. The media of claim 3, wherein the zeolite is a Faujasite-type zeolite.
